(19) United States
(12) Patent Application Publication
(10) Pub. No.: US 2007/0166535 A1
(43) Pub. Date: Jul. 19, 2007

(54) Thermoplastic polyimide composition and double-sided flexible copper clad laminate using the same

(75) Inventors: Charng-Shing Lu, Hsinchu City (TW); Jinn-Shing King, Hsinchu (TW); Shu-Shu Shih, Hsinchu City (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/511,314

(22) Filed: Aug. 29, 2006

(30) Foreign Application Priority Data
Jan. 17, 2006 (TW) 95101694

(51) Int. Cl. B32B 15/08; B32B 15/20

(52) U.S. Cl. 428/339; 428/458; 428/473.5; 528/310

(57) ABSTRACT

A thermoplastic polyimide composition characterized by improved thermal resistance, adhesion and flatness for use in copper clad laminates. The polyimide contains repeating units represented by the formulae I and II,

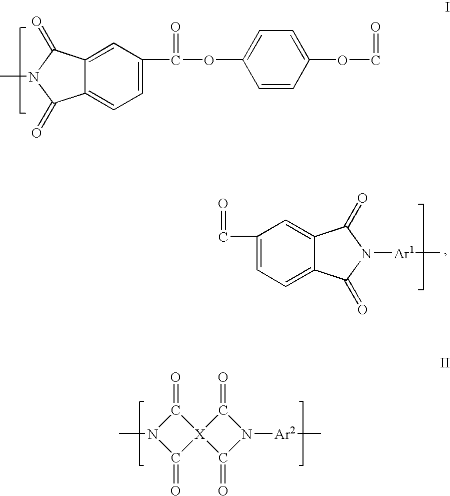

wherein each of Ar¹ and Ar², independently, represents a bivalent aromatic group, and X represents a quadrivalent aromatic group.

### BACKGROUND OF THE INVENTION

1. Field of the Invention

The invention relates to thermoplastic polyimide (PI), and in particular to a thermoplastic PI with improved heat resistance, suited for making adhesiveless doubled-sided flexible copper clad laminate (FCCL).

2. Description of the Related Art

With the recent rapid progress of miniaturization and high integration of electronic devices using flexible printed wiring boards, there is an increasing demand for double-sided laminates to cope with the trend to lighter and higher-density circuits. Conventional double-sided clad laminates include a PI base film coated with adhesives such as epoxy or urethane resin on both sides. The use of adhesives, however, increases the thickness of the final product, making it undesirable for use in fine pitch circuits. Moreover, adhesives can cause curling or result in poor dimensional stability and solder resistance. To overcome these problems, adhesiveless double-sided clad laminate has been proposed.

FIG. 1 shows a conventional method for making adhesiveless double-sided clad laminate. A PI base film 10 is coated by thermoplastic polyimide 12a, 12b on both sides and then laminated with copper foils 14a, 14b. The coating is typically performed during the B-stage of the PI base film to improve the interface adhesion and reduce the thickness. To improve the adhesion property, Japanese Patent Application Laid-Open No. 08-294993 discloses a thermoplastic polyimide having a glass transition temperature (Tg) of 150-220° C., made from flexible monomers such as ethylene glycol bis(anhydro-trimellitate) (TMEG-100) or siloxane diamine. It has been found, however, that the thermoplastic polyimide has poor dimensional stability and suffers from curling problems after copper foil etching.

FIG. 2 shows another conventional method for making adhesiveless double-sided clad laminate disclosed in U.S. Pat. No. 6,346,298. First, a copper foil 24a is coated by a first polyimide layer 22a. Next, a second polyimide layer 20 having a low coefficient of thermal expansion (CTE) is coated on the first polyimide layer 22a. Finally, a third polyimide layer 22b is coated on the second polyimide layer 20, thereby obtaining a laminated three-layer structure. The three-layer structure is subjected to imidization by a heat treatment and laminated with a second copper foil 24b to complete a double-sided copper clad laminate. Although the symmetric tri-layer structure suffers from less curling problems, the process is rather complicated.

FIG. 3 shows a further conventional method for making adhesiveless double-sided clad laminate disclosed in U.S. Pat. No. 5,112,694. A low CTE polyimide layer 30 with adhesive functions is directly coated on a copper foil 32a. After subjecting to thermal imidization, another copper foil 32b is laminated thereon. In spite of the simple process, such thermoplastic polyimide usually has a very high Tg (>300° C.), and therefore necessitates a lamination temperature above 380° C., which is higher than the operational temperature of commercial laminating machines.

Accordingly, there is a need for an improved thermoplastic polyimide which can provide good adhesion and heat resistance without needing a complicated process and high lamination temperature.

### BRIEF SUMMARY OF THE INVENTION

An object of the invention is to provide a thermoplastic polyimide composition which has improved heat resistance and good adhesion with copper foils and causes no curling after copper foil etching.

Another object of the invention is to provide a thermoplastic polyimide composition with a sufficiently high Tg for heat resistance while not causing overly high lamination temperature.

A further object of the invention is to provide a thermoplastic polyimide composition, which enables a simple process for making a double-sided flexible copper clad laminate.

To achieve the above objects, the thermoplastic polyimide composition of the invention comprises: a thermoplastic polyimide copolymer having repeating units represented by formulae I and II, and the mole fraction of the repeating unit of formula I being at least 10%,

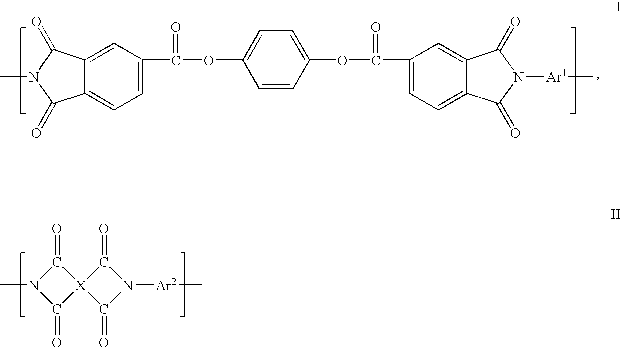

wherein each of Ar¹ and Ar², independently, represents a bivalent aromatic group, and X represents a quadrivalent aromatic group.

The invention further provides a double-sided flexible copper clad laminate, comprising a low CTE polyimide base layer and a polyimide layer formed from the above polyimide composition, sandwiched between two copper foils.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a cross section showing a conventional method for making an adhesiveless double-sided copper clad laminate;

FIG. 2 is a cross section showing another conventional method for making an adhesiveless double-sided copper clad laminate;

FIG. 3 is a cross section showing a further conventional method for making an adhesiveless double-sided copper clad laminate; and

FIG. 4 is a cross section showing a method for making an adhesiveless double-sided copper clad laminate according to a preferred embodiment of the invention.

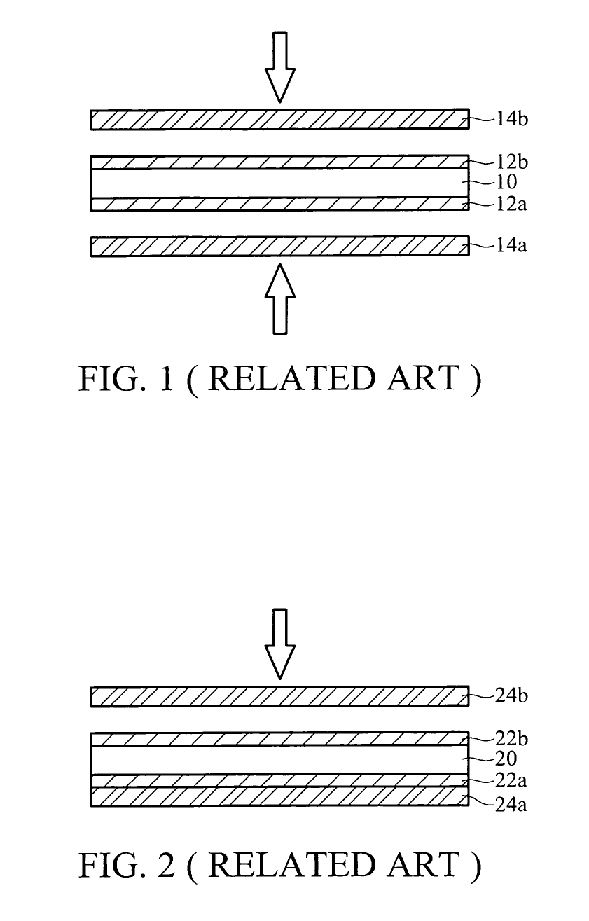

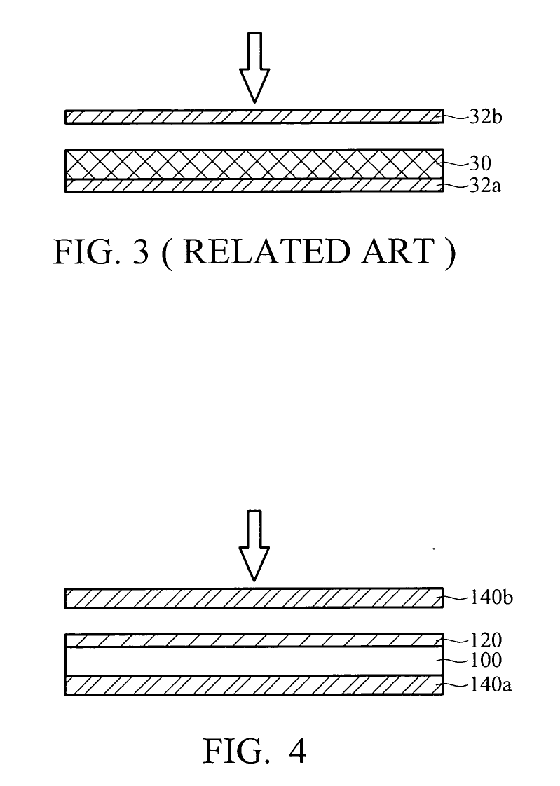

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The invention provides a novel thermoplastic polyimide copolymer. The Tg of the polyimide is controlled at about 210-300° C. by molecular design. The thermoplastic polyimide is coated on a B-stage polyimide base layer of a single-sided clad laminate, and then another copper foil is laminated on the thermoplastic polyimide to complete a doubled sided clad laminate. The laminated product obtained from the simple process shows excellent adhesive strength, solder resistance, as well as improved surface flatness.

The thermoplastic polyimide copolymer of the invention features repeating units of formulae I and II as the polymer backbone, and the mole fraction of the repeating unit of formula I is at least 10%.

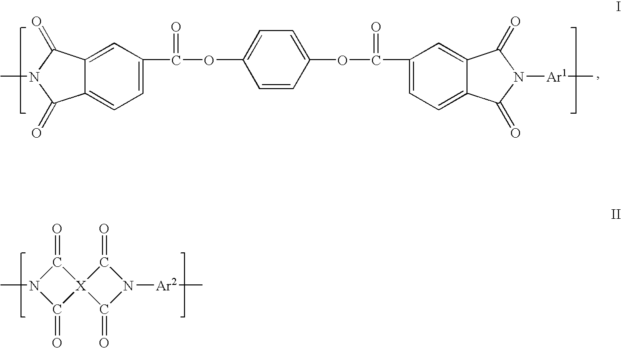

In formulae I and II, each of Ar¹ and Ar², independently, represents a bivalent aromatic group. Preferred examples of Ar¹ and Ar² include, but are not limited to:

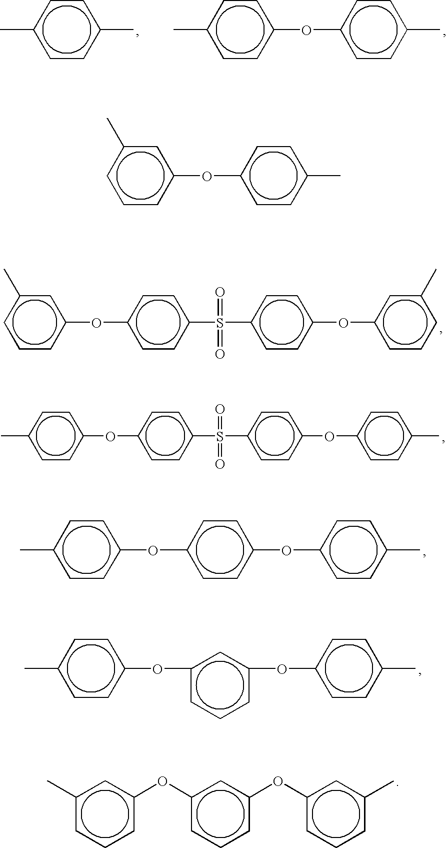

X represents a quadrivalent aromatic group. Preferred examples of X include, but are not limited to:

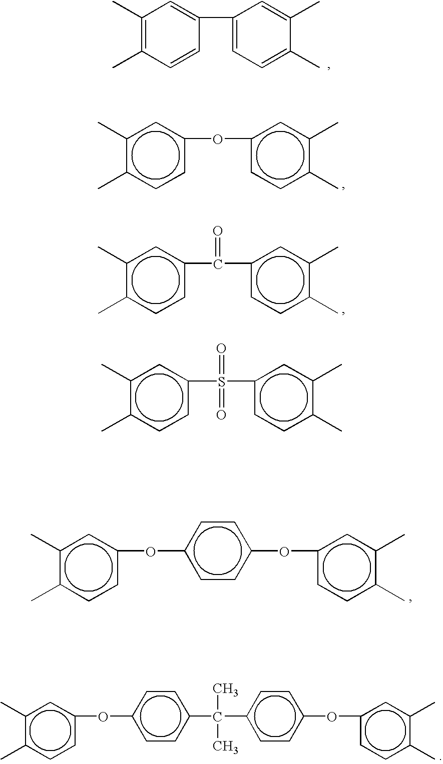

The polyimide copolymer of the invention may be a di-block copolymer, random copolymer, or alternating copolymer, depending on how monomers are feed during copolymerization. In preferred embodiments, the mole fraction of the repeating unit of formula I is about 10-90%, and that of formula II is about 90-10%.

The repeating unit of formula I is a copolymer chain formed by the reaction of 1,3-dihydro-1,3-dioxo-5-isobenzofurancarboxylic acid phenylene ester (TAHQ; a tetracarboxylic dianhydride monomer) and a divalent diamine monomer. The repeating unit of formula II is a copolymer chain formed by the reaction of a quadrivalent tetracarboxylic dianhydride monomer and a divalent diamine monomer.

The adhesive strength and Tg of the thermoplastic polyimide copolymer can be controlled by the choice of the tetracarboxylic dianhydride monomer and the diamine monomer. In this invention, the Tg is controlled between about 210° C. and 300° C., preferably between about 230° C. and 280° C. considering the lamination temperature and other desired properties. A Tg below 210° C. leads to curling of copper foils, whereas that above 300° C. results in poor adhesion to copper foils and overly high lamination temperature.

The polyimide copolymer of the invention features a specific tetracarboxylic dianhydride monomer, that is, TAHQ. In addition to excellent molecular flexibility, this monomer shows better heat resistance than the commonly used monomer TMEG-100 (ethylene glycol bis(anhydro-trimellitate)). Accordingly, TAHQ is introduced to the main backbone of the polyimide and other tetracarboxylic dianhydride and diamine monomers are selected to give the desired physical properties.

Preferred examples of the tetracarboxylic dianhydride monomer include 3,3′,4,4′-biphenyl tetracarboylic dianhydride (BPDA), 3,3′,4,4′-benzophenone-tetracarboxylic dianhydride (BTDA), 4,4′-oxydiphthalic anhydride (ODPA), 3,3′,4,4′-diphenylsulfone tetracarboxylic dianhydride (DSDA), and the like. Preferred examples of the diamine monomer include p-phenylene diamine (PPDA), 4,4′-oxydianiline (4,4′-ODA), 3,4′-oxydianiline (3,4′-ODA), 2,2-bis(4-[4-aminophenoxy]phenyl)propane (BAPP), 2,2-bis(4-[3-aminophenoxy]phenyl)sulfone (m-BAPS), 1,3-bis(4-aminophenoxy)benzene (TPE-R). It is to be noted that the tetracarboxylic dianhydride and diamine monomers are not limited to the above described examples. To the contrary, those skilled in the art will recognize that any diamine monomers may be used to react with TAHQ to form the repeating unit of formula I, and any tetracarboxylic dianhydride and diamine monomers may be used to synthesize the repeating unit of formula II, as long as the Tg of the final copolymer is controlled within the above described range.

The intrinsic viscosity (I.V.) of the thermoplastic polyimide copolymer is preferable greater than 0.75 dl/g, more preferably between 0.8-1.2. The weight average molecular weight is typically between 10,000 and 80,000 and preferably between 15,000 and 60,000.

Referring to FIG. 4, a method for making a double-sided flexible copper clad laminate using the thermoplastic polyimide of the invention is shown. First, the thermoplastic polyimide 120 of the invention is applied on the surface of a single-sided copper clad laminate comprising a copper foil 140a and a low CTE polyimide base film 100 (CTE<20 ppm/° C.). Subsequently, a heat treatment is carried out to effect imidization. Preferably, the polyimide base film 100 and thermoplastic polyimide layer 120 have thicknesses of about 20-22 μm and 3-5 μm respectively after the heat treatment. Next, a copper foil 140b is laminated onto the thermoplastic polyimide layer 120, thereby completing a double-sided flexible copper clad laminate. The lamination temperature is preferably about 50-150° C. higher than the Tg of the thermoplastic polyimide.

A small amount of inorganic additives may be added into the thermoplastic polyimide layer 120 to insure that no curling occurs after copper foil etching. Suitable inorganic additives that may be used to reduce thermal expansion include silica, talc, calcium carbonate, clay, or combinations thereof. The amount of the inorganic additive is preferably between 0.1 and 5% by weight, based on the solid content of the polyimide. It is preferable that the bulk thermal expansion coefficient of the thermoplastic polyimide layer 120 and the low CTE base film 100 be reduced to less than 30 ppm/° C. (30-250° C.). Accordingly, the invention provides a simple process for making a double-sided flexible copper clad laminate having high peeling strength, solder resistance as well as improved surface flatness.

Without intending to limit it in any manner, the present invention will be further illustrated by the following examples.

### SYNTHETIC EXAMPLE 1

11.45 g (0.7 mol) of 4,4′-ODA, 10.61 g (0.3 mol) of m-BAPS, and 250 ml of N-methyl-2-pyrrolidone/toluene co-solvent (80/20) were charged into a 500 ml four-neck reactor, and purged with nitrogen while stirring. After the diamine monomer was completely dissolved, 10.49 g (0.28 mol) of TAHQ was added to the reactor and stirred for 30 minutes at room temperature. Thereafter, 18.44 g (0.7 mol) of BTDA was divided into three portions, and each portion was added to the reactor with a time period of 30 minutes. The reaction mixture was left stirring for 3 hours after the last portion of BTDA was added, thus obtaining the thermoplastic polyimide copolymer.

### SYNTHETIC EXAMPLE 2

14.9 g (0.8 mol) of 3,4′-ODA, 5.44 g (0.2 mol) of TPE-R, and 250 ml of N-methyl-2-pyrrolidone/toluene co-solvent (80/20) were charged into a 500 ml four-neck reactor, and purged with nitrogen while stirring. After the diamine monomer was completely dissolved, 10.66 g (0.25 mol) of TAHQ was added to the reactor and stirred for 30 minutes at room temperature. Thereafter, 19.98 g (0.73 mol) of BPDA was divided into three portions, and each portion was added to the reactor with a time period of 30 minutes. The reaction mixture was left stirring for 3 hours after the last portion of BPDA was added, thus obtaining the thermoplastic polyimide copolymer.

### SYNTHETIC EXAMPLE 3

12.65 g (0.78 mol) of 3,4′-ODA, 7.71 g (0.22 mol) of m-BAPS, and 250 ml of N-methyl-2-pyrrolidone/toluene co-solvent (80/20) were charged into a 500 ml four-neck reactor, and purged with nitrogen while stirring. After the diamine monomer was completely dissolved, 18.57 g (0.5 mol) of TAHQ was divided into two portions and each portion was added to the reactor at room temperature with a time period of 30 minutes. Thereafter, 12.08 g (0.48 mol) of OPDA was divided into two portions, and each portion was added to the reactor with a time period of 30 minutes. The reaction mixture was left stirring for 3 hours after the last portion of OPDA was added, thus obtaining the thermoplastic polyimide copolymer.

### SYNTHETIC EXAMPLE 4

To 100 g of the thermoplastic polyimide copolymer of Synthetic Example 3 was added 3% by weight of silica powder, based on the weight of the polyimide copolymer. The mixture was ground on a three-roller mill, thus providing a thermoplastic polyimide copolymer containing inorganic additive.

### SYNTHETIC EXAMPLE 5

6.75 g (0.3 mol) of 4,4′-ODA, 8.51 g (0.7 mol) of p-PDA, and 250 ml of N-methyl-2-pyrrolidone/toluene co-solvent (80/20) were charged into a 500 ml four-neck reactor, and purged with nitrogen while stirring. After the diamine monomer was completely dissolved, 9.27 g (0.18 mol) of TAHQ was added to the reactor and stirred for 30 minutes at room temperature. Thereafter, 26.46 g (0.8 mol) of BPDA was divided into three portions, and each portion was added to the reactor with a time period of 30 minutes. The reaction mixture was left stirring for 3 hours after the last portion of BPDA was added, thus obtaining the thermoplastic polyimide copolymer.

### SYNTHETIC EXAMPLE 6

10.65 g (0.7 mol) of 4,4′-ODA, 9.37 g (0.3 mol) of BAPP, and 250 ml of N-methyl-2-pyrrolidone/toluene co-solvent (80/20) were charged into a 500 ml four-neck reactor, and purged with nitrogen while stirring. After the diamine monomer was completely dissolved, 6.61 g (0.28 mol) of ODPA was added to the reactor and stirred for 30 minutes at room temperature. Thereafter, 24.40 g (0.7 mol) of TAHQ was divided into three portions, and each portion was added to the reactor with a time period of 30 minutes. The reaction mixture was left stirring for 3 hours after the last portion of TAHQ was added, thus obtaining the thermoplastic polyimide copolymer.

### SYNTHETIC EXAMPLE 7

5.84 g (0.33 mol) of 1,3-bis(bisaminopropyl)tetramethyl disiloxane (Siloxane248), 20.69 g (0.67 mol) of m-BAPS, and 250 ml of N-methyl-2-pyrrolidone/toluene co-solvent (80/20) were charged into a 500 ml four-neck reactor, and purged with nitrogen while stirring. After the diamine monomer was completely dissolved, 9.66 g (0.33 mol) of TMEG-100 was added to the reactor and stirred for 30 minutes at room temperature. Thereafter, 14.83 g (0.67 mol) of OPDA was divided into three portions, and each portion was added to the reactor with a time period of 30 minutes. The reaction mixture was left stirring for 3 hours after the last portion of OPDA was added, thus obtaining the thermoplastic polyimide copolymer.

### EXAMPLES 1-6

The thermoplastic polymers of Synthetic Examples 1-6 were coated on B-stage polyimide films of single-sided copper foil laminates, respectively. The B-stage polyimide film had a low CTE and was co-polymerized from BPDA, BTDA, P-PDA, and 4,4′-ODA. The coated laminates were heated at 120° C. for 30 minutes, 250° C. for 30 minutes, and 350° C. for one hour to effect imidization. A copper foil was superposed and laminated on the resulting thermoplastic polyimide films to yield double-sided copper clad laminates of Examples 1-6.

The physical properties of the double-sided copper clad laminates were listed in Table 1. The peeling strength was measured following the procedure of IPC-TM-650 (2.4.9), and the solder resistance was measured following the procedure of IPC-TM-650 (2.4.13). The curling properties of the clad laminates were evaluated as follows before copper foil etching, after one side etching, and dual side etching, respectively. The clad laminates were cut into A4 size test specimens. The test specimens were attached to a wall with the upper ends pressed by a ruler against the wall, and the distances of the lower ends with respect to the wall were measured. The measured distances of the (lower) right side end and (lower) left side end were averaged.

### COMPARATIVE EXAMPLE 1

The same procedure as in Examples 1-6 was repeated except that the thermoplastic polyimide was replaced with the thermoplastic polyimide of Synthetic Example 7 having TMEG-100 monomer. The physical properties of the resulting clad laminate are also listed in Table 1.

### COMPARATIVE EXAMPLE 2

A commercial adhesiveless double-sided copper clad laminate SB18-25-18-FR (from Nippon Steel Chemical Co., Ltd.) was measured for the physical properties by the same procedure for comparison. The laminate had a three-layer structure of thermoplastic polyimide/low CTE polyimide base film/thermoplastic polyimide.

TABLE 1

| | | | | | | | | Com. | Com. |
|---|---|---|---|---|---|---|---|---|---|
| | | Ex. 1 | Ex. 2 | Ex. 3 | Ex. 4 | Ex. 5 | Ex. 6 | Ex. 1 | Ex. 2 |
| Thickness of low CTE PI | | 21 | 20 | 21 | 20 | 20 | 21 | 22 | 20 |
| film (μm) | | | | | | | | | |
| Thermoplastic PI | | Syn. | Syn. | Syn. | Syn. | Syn. | Syn. | Syn. | — |
| | | Ex. 1 | Ex. 2 | Ex. 3 | Ex. 4 | Ex. 5 | Ex. 6 | Ex. 7 | |
| Tg of thermoplastic PI (° C.) | | 248 | 265 | 232 | 235 | 280 | 218 | 162 | — |
| Thickness of thermoplastic | | 4 | 5 | 4 | 5 | 5 | 4 | 3 | 2~3 |
| PI (μm) | | | | | | | | | |
| Bulk CTE (ppm/° C.) | | 27 | 28 | 29 | 25 | 26 | 32 | 37 | 26 |
| Lamination | temp (° C.) | 330 | 350 | 320 | 320 | 320 | 320 | 260 | — |
| conditions | pressure (kg/cm²) | 60 | 60 | 60 | 60 | 40 | 40 | 40 | — |
| | time (min) | 10 | 10 | 10 | 10 | 10 | 10 | 5 | — |
| Surface | before copper | flat | flat | flat | flat | flat | slight | curl | flat |
| flatness | foil etching | | | | | | curl | (>5 cm) | |
| | | | | | | | (1.2 cm) | | |
| | one side etching | flat | flat | flat | flat | flat | slight | curl | flat |
| | | | | | | | curl | (>5 cm) | |
| | | | | | | | (3.5 cm) | | |
| | dual side etching | flat | flat | slight | flat | flat | curl | curl | flat |
| | | | | curl | | | (>5 cm) | (>5 cm) | |
| | | | | (1.8 cm) | | | | | |

| | | | | | | | | |
|---|---|---|---|---|---|---|---|---|
| Peeling strength (lb/in) | 7.8 | 6.5 | 7.5 | 6.8 | 5.1 | 7.2 | 7.5 | 6.8 |
| Solder resistance | pass | pass | pass | pass | pass | pass | poor | pass |
| (288° C. * 30 sec) | | | | | | | | |

As can be seen from Table 1, the copper clad laminates made from the thermoplastic polyimide of the invention had excellent surface flatness, except that a slight curling was present in Example 5 after copper foil etching. In addition to the poor solder resistance, Comparative Example 1 using TMEG-100 monomer suffered serious curling problems even before copper foil etching.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A thermoplastic polyimide composition, comprising:
a thermoplastic polyimide copolymer having repeating units represented by formulae I and II, and the mole fraction of the repeating unit of formula I being at least 10%, 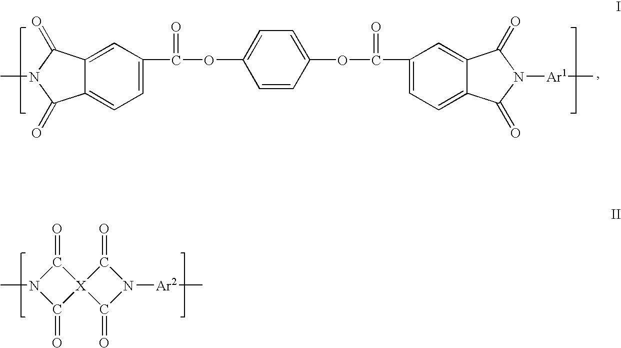
wherein each of Ar¹ and Ar², independently, represents a bivalent aromatic group, and X represents a quadrivalent aromatic group.

2. The thermoplastic polyimide composition as claimed in claim 1, wherein each of Ar¹ and Ar², independently, represents at least one of the bivalent aromatic groups specified below:

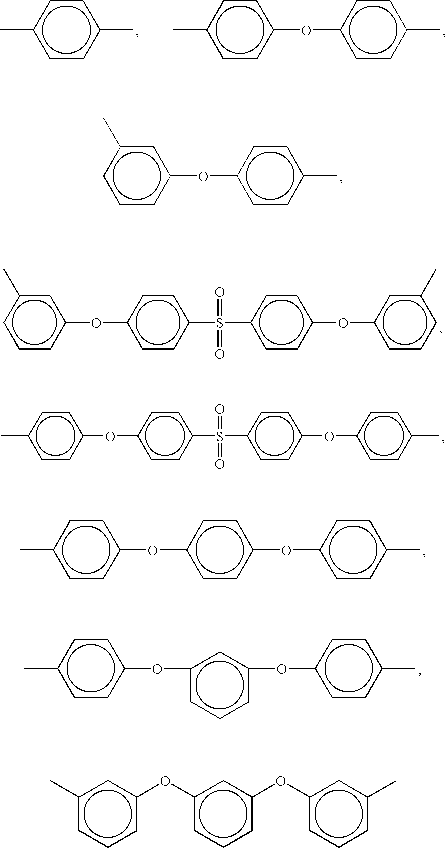

3. The thermoplastic polyimide composition as claimed in claim 1, wherein X represents at least one of the quadrivalent aromatic groups specified below:

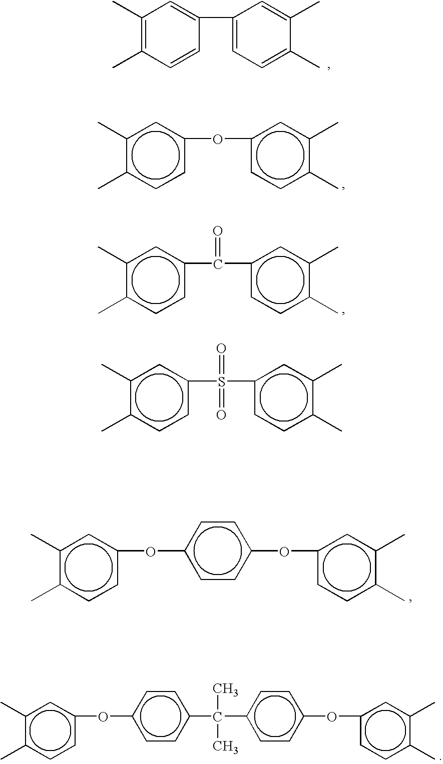

4. The thermoplastic polyimide composition as claimed in claim 1, wherein the thermoplastic polyimide copolymer has a glass transition temperature (Tg) of about 210-300° C.

5. The thermoplastic polyimide composition as claimed in claim 1, wherein the thermoplastic polyimide copolymer has a glass transition temperature (Tg) of about 230-280° C.

6. The thermoplastic polyimide composition as claimed in claim 1, wherein the mole fraction of the recurring unit of formula I is about 10-90%, and the mole fraction of the recurring unit of formula II is about 90-10%.

7. The thermoplastic polyimide composition as claimed in claim 1, wherein the thermoplastic polyimide copolymer exhibits an intrinsic viscosity (I.V.) not less than 0.75 dl/g.

8. The thermoplastic polyimide composition as claimed in claim 1, further comprising an inorganic additive.

9. The thermoplastic polyimide composition as claimed in claim 1, wherein the inorganic additive comprises at least one of silica, talc, calcium carbonate, and clay.

10. A double-sided flexible copper clad laminate, comprising:
a first polyimide film and a second polyimide film, sandwiched between two copper foils, wherein
the first polyimide film has a lower thermal expansion coefficient than the second polyimide film; and
the second polyimide film comprising the thermoplastic polyimide composition of claim 1.

11. The double-sided flexible copper clad laminate as claimed in claim 10, wherein the second polyimide film has a thickness of about 3-5 μm.

12. The double-sided flexible copper clad laminate as claimed in claim 10, wherein a bulk thermal expansion coefficient of the first and second polyimide films is less than 30 ppm/° C.
